(19) United States
(12) Patent Application Publication
(10) Pub. No.: US 2016/0041659 A1
(43) Pub. Date: Feb. 11, 2016

(54) TOUCH PANELS AND FABRICATION METHODS THEREOF

(71) Applicant: InnoLux Corporation, Miao-Li County (TW)

(72) Inventors: Huang-Cho CHEN, Miao-Li County (TW); Tung-Chang TSAI, Miao-Li County (TW); Hung-Sheng CHO, Miao-Li County (TW)

(21) Appl. No.: 14/818,098

(22) Filed: Aug. 4, 2015

(30) Foreign Application Priority Data
Aug. 7, 2014 (TW) 103127029

(51) Int. Cl. G06F 3/047; G06F 3/044; G09G 5/00

(52) U.S. Cl. CPC G06F 3/047; G09G 5/003; G06F 3/044; G09G 2300/0426

(57) ABSTRACT

A touch panel is provided. The touch panel includes a plurality of first electrodes disposed on a substrate. The first electrodes are parallel to each other and extend along a first direction. A conductive photoresist film including a plurality of second electrodes and an insulating photo-sensitive material layer is disposed on the first electrodes. The second electrodes are parallel to each other and extend along a second direction perpendicular to the first direction. The insulating photo-sensitive material layer is disposed between the first and second electrodes. Furthermore, a fabrication method of a touch panel is also provided. The method includes using a conductive photoresist film to form the touch panel.

### CROSS REFERENCE TO RELATED APPLICATIONS

This Application claims priority of Taiwan Patent Application No. 103127029, filed on Aug. 7, 2014, the entirety of which is incorporated by reference herein.

### BACKGROUND OF THE INVENTION

1. Field of the Invention

The present invention relates to touch panel technology, and in particular to the electrode pattern design of touch panels and touch panels formed by a conductive photoresist film, and the fabrication methods thereof.

2. Description of the Related Art

Along with developments in the electronics industry, various digital products, such as mobile phones, tablet computers, digital cameras and other electronic devices, have the requirement of touch functionality. Using touch panels on electronic products can provide faster and more convenient operation. The capacitance touch panel is the main technology used in current touch panels. The layer structure of the capacitance touch panel generally includes a first conductive layer, a second conductive layer and an insulating layer between the first and second conductive layers.

The electrode pattern of the first conductive layer of the touch panel is generally formed by depositing a transparent conductive layer and patterning the transparent conductive layer with lithography and etching process. Another depositing, lithography and etching process is needed for forming the electrode pattern of the second conductive layer. Another depositing, lithography and etching process is needed to form the insulating layer disposed between the first and second layers.

The electrode patterns of the first and second conductive layers usually use a rhombus electrode pattern design. The rhombus electrodes of the pattern are arranged in a plurality of rows and a plurality of columns, and the rhombus electrode patterns are electrically connected by a bridged portion. An intersection of the first and second conductive layers is located in the bridged portion between the rhombus electrode patterns.

When an alignment shift occurs between the first and second conductive layers with the rhombus electrode patterns designs, the intersection of the first and second conductive layers would occur between a portion of the rhombus electrode patterns and the bridged portion. The overlapping area of the intersection of the first and second conductive layers would change after an alignment shift occurs, and the distance of the rhombus electrode patterns between the first and second conductive layers is also changed. Therefore, the value of the capacitance generated by the rhombus electrode patterns with an alignment shift changes strongly with respect to the capacitance generated by the rhombus electrode patterns without an alignment shift. The touch sensitivity of the touch panel is thereby affected.

Therefore, the process for fabricating a capacitance-type touch panel is complicated. A high degree of accuracy is required in the alignment of the electrode patterns between the first and second layers.

### BRIEF SUMMARY OF THE INVENTION

The disclosure provides an electrode pattern design for touch panels. The disclosure uses a bar-type electrode pattern design so that when the alignment shift occurs between the first electrode and the second electrode that is perpendicular to the first electrode, the overlapping area between the first electrode and the second electrode will not change, and the total capacitance value generated between the first electrode and the second electrode also do not change. Therefore, the capacitance value generated by the electrode pattern of the touch panel is not affected by the alignment shift, and the touch sensitivity of the touch panel is thereby improved.

Additionally, the disclosure also provides a fabrication method of the touch panel by using a conductive photoresist film. Using the conductive photoresist film would integrate a process of fabricating a conductive layer and an insulating layer of the touch panel. Therefore, the process of manufacturing the touch panel is simplified.

In some embodiments of the disclosure, a touch panel is provided. The touch panel comprises a plurality of first electrodes disposed over a substrate. The first electrodes are parallel to each other and extend along a first direction. A conductive photoresist film is disposed over the first electrodes. The conductive photoresist film comprises an insulating photo-sensitive material layer and a plurality of second electrodes. The second electrodes are parallel to each other and extend along a second direction. The second direction is perpendicular to the first direction. The insulating photo-sensitive material layer is between the first electrodes and the second electrodes.

In some embodiments of the disclosure, a method for forming a touch panel is provided. The method comprises forming a plurality of first electrodes over a substrate. The first electrodes are parallel to each other and extend along a first direction. A conductive photoresist film is attached on the first electrodes. The conductive photoresist film comprises an insulating photo-sensitive material layer and a conductive layer. The conductive layer is patterned to form a plurality of second electrodes. The second electrodes are parallel to each other and extend along a second direction. The second direction is perpendicular to the first direction. The insulating photo-sensitive material layer is between the first electrodes and the second electrodes.

In some embodiments of the disclosure, a display device is provided. The display device comprises a display panel and a touch panel disposed on the display panel, wherein the touch panel comprises a plurality of first electrodes disposed over a substrate. The first electrodes are parallel to each other and extend along a first direction. A conductive photoresist film is disposed over the first electrodes. The conductive photoresist film comprises an insulating photo-sensitive material layer and a plurality of second electrodes. The second electrodes are parallel to each other and extend along a second direction. The second direction is perpendicular to the first direction. The insulating photo-sensitive material layer is between the first electrodes and the second electrodes.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a plane view of a touch panel according to some embodiments of the disclosure;

FIG. 2 shows a cross section of a touch panel along a cross section line I-I′ of FIG. 1 according to some embodiments of the disclosure;

FIG. 3A-3D show a plane view of intermediate steps of fabrication of a touch panel with respect to FIG. 2 according to some embodiments of the disclosure;

FIGS. 4 shows a cross section of a touch panel along a cross section line I-I′ of FIG. 1 according to some other embodiments of the disclosure;

FIG. 5A-5F show plane view of intermediate steps of fabrication of a touch panel with respect to FIG. 4 according to some embodiments of the disclosure;

FIG. 6 shows a cross section of a display device according to some embodiments of the disclosure;

### DETAILED DESCRIPTION OF THE INVENTION

The following description is of the contemplated mode of carrying out the structure designs and fabrication methods of some embodiments of the touch panels of the disclosure. This description is made for the purpose of illustrating the general principles of the disclosure and should not be taken in a limiting sense. The scope of the invention is best determined by reference to the appended claims.

Moreover, in the descriptions of the embodiments that follow, the orientations of “on”, “over”, “above”, “under” and “below” are used for representing the relationship between the relative positions of each element in the touch panels, and not used to limit the present disclosure. In addition, a first element formed “on”, “over”, “above”, “under” or “below” a second element comprises embodiments having the first element in direct contact with the second element, or embodiments having additional elements inserted between the first element and the second element so that the first element is not in direct contact with the second element.

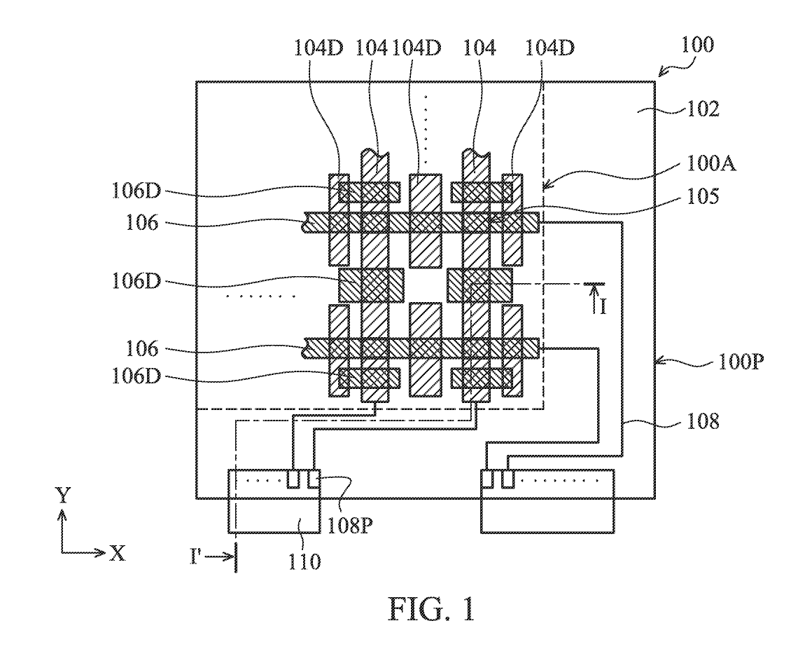

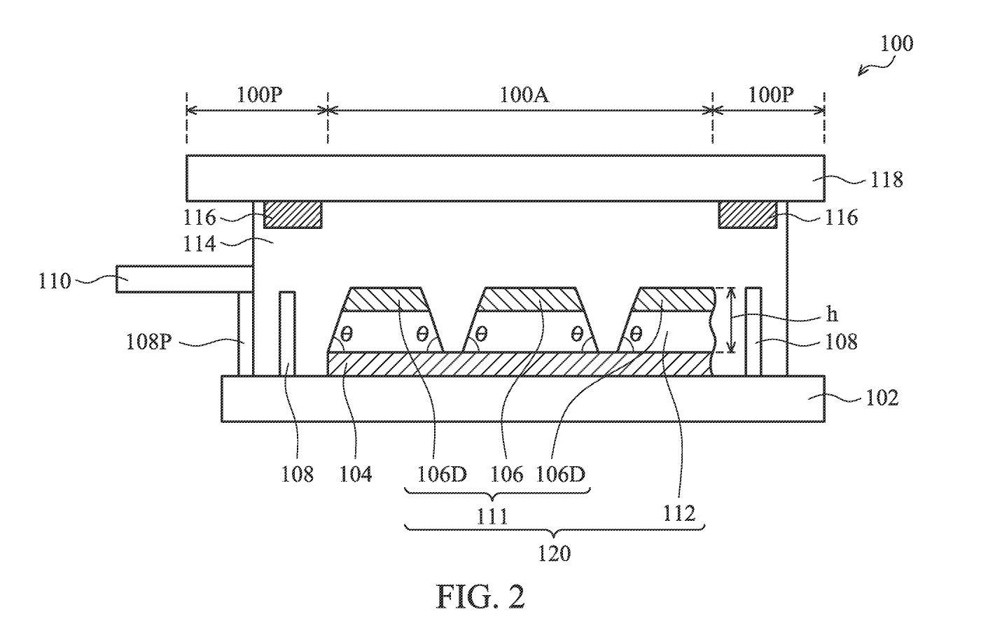

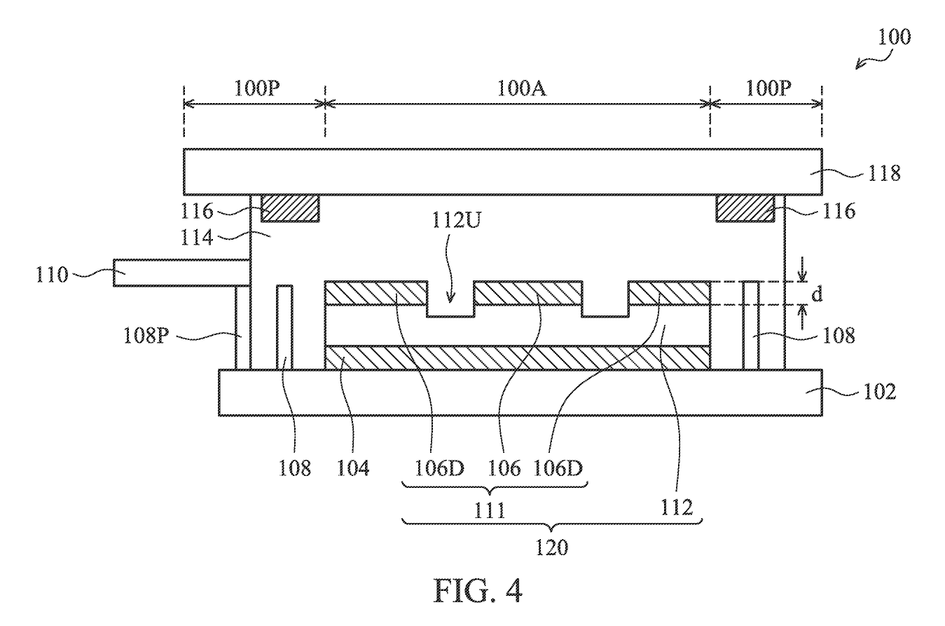

As shown in FIG. 1, a touch panel 100 includes a plurality of bar-type first electrodes 104 formed over a substrate 102. The first electrodes 104 are parallel to each other and extend along a first direction such as a Y-axis. Additionally, the touch panel 100 also includes a plurality of bar-type second electrodes 106 formed above the first electrode 104. The second electrodes 106 are parallel to each other and extend along a second direction such as a X-axis so that the second electrodes 106 are perpendicular to the first electrodes 104. To avoid a short-circuit at the intersection between the first electrodes 104 and the second electrodes 106, an insulating layer is disposed between the first electrodes 104 and the second electrodes 106. The insulating layer is an insulating photo-sensitive material layer. The insulating photo-sensitive material layer and the second electrodes 106 are made of a conductive photoresist film. The insulating photo-sensitive material layer is not illustrated in FIG. 1, but it is illustrated in FIGS. 2 and 4.

As shown in FIG. 1, there is a plurality of dummy first electrodes 104D between the neighboring first electrodes 104. The disposition of the dummy first electrodes 104D does not provide touch function, but improves the sensitivity of the touch sensor and reduces the visual problems caused by the visible shape of the first electrodes 104. Similarly, there is a plurality of dummy second electrodes 106D between the neighboring second electrodes 106. The disposition of the dummy second electrodes 106D does not provide a touch function, but improves the sensitivity of the touch sensor and also reduces the visual problems caused by the visible shape of the second electrodes 106.

Furthermore, the touch panel 100 also includes a plurality of wires 108 which connects to the first electrodes 104 and the second electrodes 106, and the wires 108 electrically connect to a flexible print circuit (FPC) 110 through conductive pads 108P. The area in which the first electrodes 104, the dummy first electrodes 104D, the second electrodes 106 and the dummy second electrodes 106D are disposed is referred to as an active area 100A of the touch panel 100. The area in which the wires 108 and the conductive pad 108P are disposed is referred to as a peripheral area 100P of the touch panel 100.

FIG. 2 shows a cross section of a touch panel 100 along a cross section line I-I′ of FIG. 1 according to some embodiments of the disclosure. The first electrodes 104 and the dummy first electrodes 104D (not illustrated in FIG. 2) are formed over the substrate 102. In some embodiments, the first electrodes 104 and the dummy first electrodes 104D may be made of a transparent conductive material, such as indium tin oxide (ITO) or indium zinc oxide (IZO). In some other embodiments, the first electrodes 104 and the dummy first electrodes 104D are made of metal lines or a metal mesh.

The second electrodes 106 and the dummy second electrodes 106D are formed over the first electrodes 104, and there is an insulating photo-sensitive material layer 112 between the second electrodes 106, the dummy second electrodes 106D and the first electrodes 104. The insulating photo-sensitive material layer 112 is used to separate the first electrodes 104 and the dummy first electrodes 104D from the second electrodes 106 and the dummy second electrodes 106D. According to some embodiments of the disclosure, the second electrodes 106, the dummy second electrodes 106D and the insulating photo-sensitive material layer 112 are made of a conductive photoresist film 120. The conductive photoresist film 120 includes the insulating photo-sensitive material layer 112 and a conductive layer 111. The conductive layer 111 of the conductive photoresist film 120 is patterned in a process to form the second electrodes 106 and the dummy second electrodes 106D. The insulating photo-sensitive material layer 112 of the conductive photoresist film 120 is patterned in the process to separate the first electrodes 104 from the second electrodes 106, the first electrodes 104 from the dummy second electrodes 106D, the dummy first electrodes 104D from the second electrodes 106 and the dummy first electrodes 104D from the dummy second electrodes 106D, respectively.

In some embodiments, the conductive layer 111 of the conductive photoresist film 120 is made of a transparent conductive material, such as indium tin oxide (ITO) or indium zinc oxide (IZO). Additionally, the conductive layer 111 of the conductive photoresist film 120 also can be made of a carbon nanotube (CNT), grapheme, Ag nanowire (AGNW), a metal mesh or a conductive polymer, such as poly(3,4-ethylenedioxythiophene) (PEDOT). The insulating photo-sensitive material layer 112 of the conductive photoresist film 120 can be made of a photoresist or an insulating glue. In some embodiments, the insulating photo-sensitive material layer 112 is dry film photoresist. In some embodiments, the thickness h of the conductive photoresist film 120 is between 1 um and 15 um, and preferably between 2.5 um and 5 um. In some other embodiments, the thickness h of the conductive photoresist film 120 can be in another range of values.

As shown in FIG. 1, the bar-type first electrodes 104 are perpendicular to the bar-type second electrodes 106. An overlapping area 105 between the first electrodes 104 and the second electrodes 106 is a rectangle shape at an intersection of the first electrodes 104 and the second electrodes 106. The overlapping area 105 is not changed when an alignment shift occurs between the first electrode 104 and the second electrode 106.

Therefore, even if the alignment shift occurs between the first electrode 104 and the second electrodes 106, the total capacitance value generated between the first electrodes 104 and the second electrode 106 is not changed through the electrode pattern design of the disclosure. The capacitance value generated by the electrode pattern of the touch panel is not affected by the alignment shift between the first electrodes 104 and the second electrodes 106. The touch sensor sensitivity of the touch panel is thereby improved.

In some embodiments of the disclosure, the conductive layer 111 of the conductive photoresist film 120 can be made of a silver nanowire. The second electrodes 106 and the dummy second electrodes 106D are made of silver nanowire. The second electrodes 106 and the dummy second electrodes 106D are buried in the surface of the conductive photoresist film 120. The change of the resistance to size of the silver nanowire is non-linear. When the first electrode 104 is formed of indium tin oxide (ITO), the change of the resistance to the size of the indium tin oxide (ITO) is linearly. A line width of the second electrodes 106 need to be set within a range according to the thickness h of the conductive photoresist film 120, and the overlapping area 105 between the first electrodes 104 and the second electrodes 106 also be set within this range according the same reason so that the resistance of the silver nanowire made second electrodes 106 could match the resistance of the indium tin oxide (ITO) first electrodes 104, and the resistance of the first electrodes 104 and the second electrodes 106 could match the request of the resistance for driving integrated circuit (IC) of the touch panel.

In some embodiments, the second electrodes 106 are made of silver nanowire, and the first electrodes 104 are made of indium tin oxide (ITO). When the thickness h of the conductive photoresist film 120 is 2.5 um, the overlapping area 105 (also referred to as the node area of a touch unit) between the first electrodes 104 and the second electrodes 106 can be between 0.04 mm² and 0.18 mm².

In some other embodiments, the second electrodes 106 are made of silver nanowire, and the first electrodes 104 are made of indium tin oxide (ITO). When the thickness h of the conductive photoresist film 120 is 5 um, the overlapping area 105 between the first electrodes 104 and the second electrodes 106 can be between 0.04 mm² and 0.36 mm². In other embodiments, the first electrodes 104 and the second electrodes 106 can be made of other materials, and the thickness h of the conductive photoresist film 120 also can be another range of values. Therefore, the overlapping area 105 between the first electrodes 104 and the second electrodes 106 can be set to another range of values according to these different conditions. For example, when the thickness h of the conductive photoresist film 120 is 1 um, the overlapping area 105 between the first electrodes 104 and the second electrodes 106 can be between 0.04 mm² and 0.072 mm². When the thickness h of the conductive photoresist film 120 is 10 um, the overlapping area 105 between the first electrodes 104 and the second electrodes 106 can be between 0.04 mm² and 0.72 mm². When the thickness h of the conductive photoresist film 120 is 15 um, the overlapping area 105 between the first electrodes 104 and the second electrodes 106 can be between 0.04 mm² and 1.08 mm².

In the embodiment of the FIG. 2, the second electrodes 106, the dummy second electrodes 106D and the insulating photo-sensitive material 112 are formed in the same process. By exposing the conductive photoresist film 120 and lithography, the second electrodes 106, the dummy second electrodes 106D and the insulating photo-sensitive material 112 can be formed simultaneously and thereby have the common tilt sides. Namely, the conductive photoresist film 120 has the tilt sides, and the tilt sides have an angle θ between 30° and 85° with respect to the surface of the first electrodes 104. Generally, the angle θ is set as 50° to 60°.

Because the second electrodes 106, the dummy second electrodes 106D and the insulating photo-sensitive material 112 are formed simultaneously through the conductive photoresist film 120, the tilt sides of the second electrodes 106, the dummy second electrodes 106D and the insulating photo-sensitive material 112 is difficult to get a vertical (90°) side. Additionally, when the angle θ of the tilt side of the second electrodes 106, the dummy second electrodes 106D and the insulating photo-sensitive material 112 is less than 30° with respect to the surface of the first electrodes 104, this means that there is poor development of the conductive photoresist film 120 which can cause a short-circuit between the second electrodes 106 and the dummy second electrodes 106D.

Furthermore, when the angle θ of the tilt side of the second electrodes 106, the dummy second electrodes 106D and the insulating photo-sensitive material 112 is greater than 85° with respect to the surface of the first electrodes 104, this means that there is over development of the conductive photoresist film 120 which can cause the second electrodes 106 and the dummy second electrodes 106D to become stripped. Therefore, setting the angle θ as 30° to 85° can avoid the aforementioned problems.

As shown in FIG. 2, there is another substrate 118 over the substrate 102. In some embodiments, the substrate 102 is a flexible plastic substrate, such as a polyethylene terephthalate (PET) substrate. The substrate 118 is a glass substrate used as a cover lens. A light-shielding layer 116 is formed on the inner surface of the substrate 118, and the outer surface of the substrate 118 is used as the touch surface of the touch panel 100.

The light-shielding layer 116 is located in the peripheral area 100P of the touch panel 100. It would cover the wires 118 by disposing the light-shielding layer 116 to avoiding any reflection generated by the wires 118 which are made of metal material, affecting the appearance of the touch panel 100. The material of the light-shielding layer 116 can be a photoresist or ink material that is black or another color. The light-shielding 116 layer can be made of black photoresist by a dispersing and photolithography process, or it can be made of multicolored ink by a printing process.

Additionally, a protection layer 114 is also formed over the substrate 102, completely covering the first electrodes 104, the dummy first electrodes 104D, the second electrodes 106, the dummy second electrodes 106D, the insulating photo-sensitive material layer 112 and the wires 118. In some embodiments, the material of the protective layer 114 can be an optical clear adhesive (OCA). The substrate 102 and the substrate 118 can be bonded together by the optical clear adhesive.

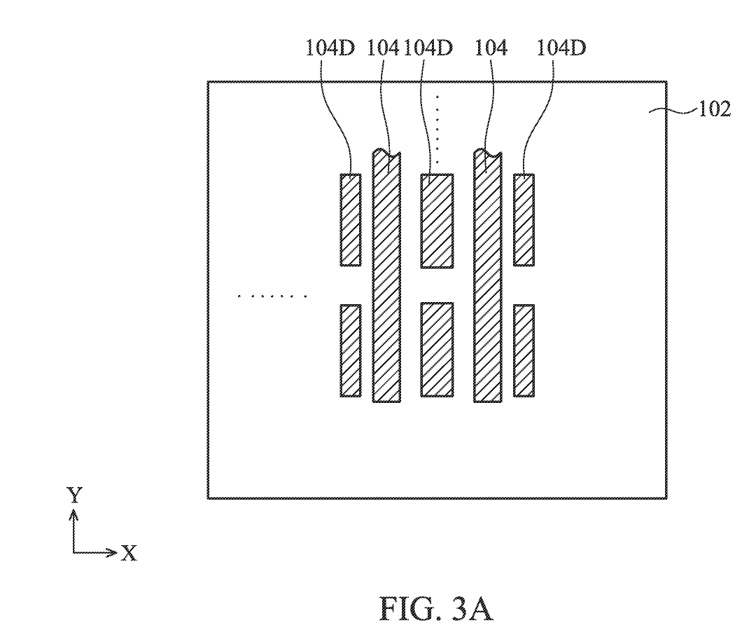

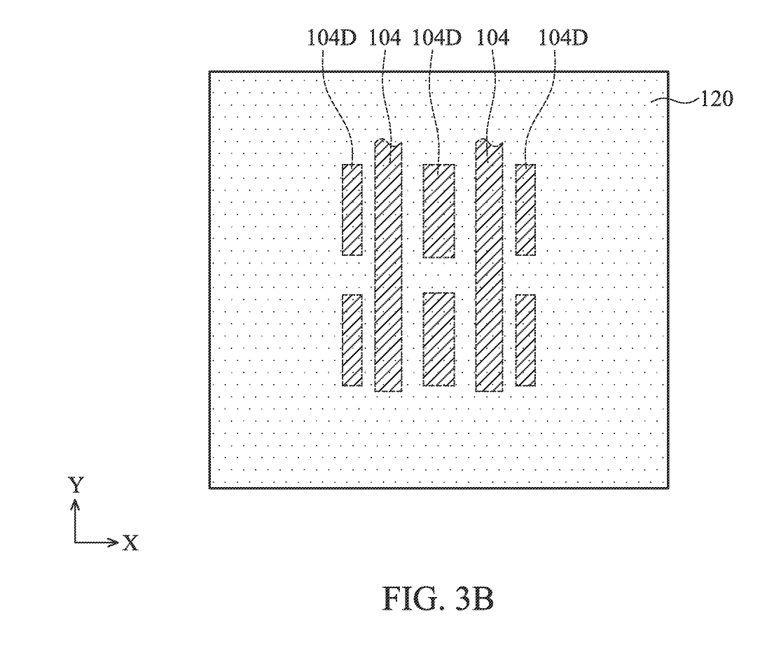

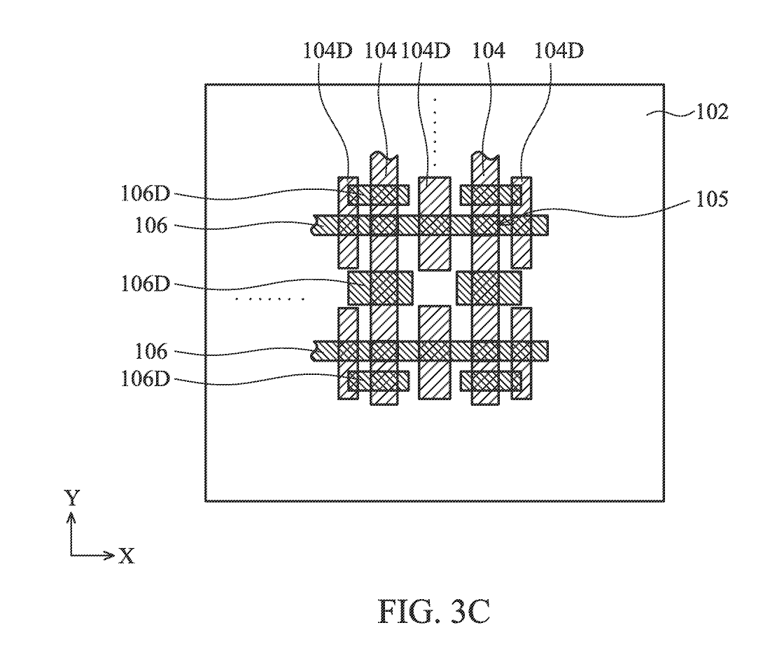

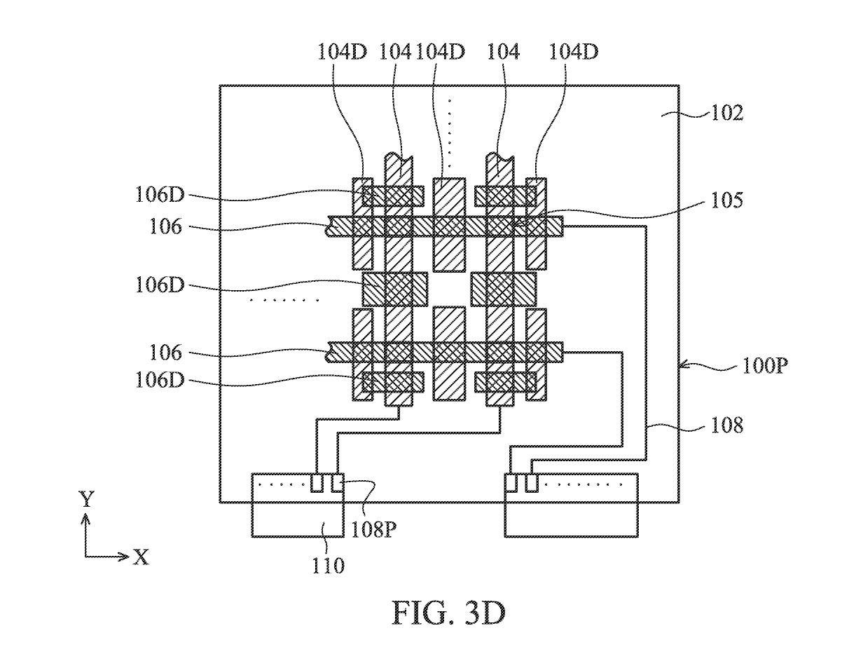

FIGS. 3A-3D show a plane view of an intermediate step in the fabrication of a touch panel 100 with respect to FIG. 2 according to some embodiments of the disclosure. As shown in FIG. 3A, the first electrodes 104 and the dummy first electrodes 104D are formed over the substrate 102. In an embodiment, an indium tin oxide (ITO) layer can be deposited over the substrate 102. A photoresist layer is formed over the indium tin oxide (ITO) layer. A photoresist pattern that matches the pattern of the first electrodes 104 and the dummy first electrodes 104D is formed by an exposure and development process. The photoresist pattern is used as a mask, and the first electrodes 104 and the dummy first electrodes 104D are formed by patterning the indium tin oxide (ITO) layer with an etching process.

Referring to FIG. 3B, the conductive photoresist film 120 is attached on the substrate 102 for covering the first electrodes 104 and the dummy first electrodes 104D. At this point, the conductive photoresist film 120 includes a non-patterned conductive layer and an underlying non-patterned insulating photo-sensitive material layer.

As shown in FIG. 3C, the conductive layer and the insulating photo-sensitive material layer of the conductive photoresist film 120 are patterned together in an exposure and development process, wherein the conductive layer forms the second electrodes 106 and the dummy second electrodes 106D (as shown in FIG. 2 respect to the conductive layer 111). At the same time, the insulating photo-sensitive material layer forms the insulating photo-sensitive material layer between the second electrodes 106, the dummy second electrodes 106D and the first electrodes 104 (as shown in FIG. 2 respect to the insulating photo-sensitive material layer 112). The insulating photo-sensitive material layer 112 has a pattern that matches the pattern of the second electrodes 106 and the dummy second electrodes 106D.

Referring to FIG. 3D, a plurality of wires 108 and conductive pads 108P on the end side of the wires 108 are formed over the substrate 102 in the peripheral area 100P of the touch panel 100. The wires 108 connect to every first electrode 104 and second electrode 106. In an embodiment, by using a screen printing process, silver paste is used for printing the pattern of the wires 108 and the conductive pads 108D, and then the wires 108 and the conductive pads 108D are formed by a baking process. Additionally, a laser etching process may be performed for reducing the line width of the wires 108.

FIG. 4 shows a cross section of a touch panel 100 along a cross section line I-I′ of FIG. 1 according to another embodiment of the disclosure. The difference between FIG. 4 and FIG. 2 is that the insulating photo-sensitive material layer 112 of the conductive photoresist film 120 is not patterned along with the conductive layer 111 in FIG. 4. After the conductive layer 111 of the conductive photoresist film 120 forms the second electrodes 106 and the dummy second electrodes 106D, the insulating photo-sensitive material layer 112 in the active area 100A of the touch panel 100 is not patterned, and it forms the insulating photo-sensitive material layer 112 which completely covers the active area 100A of the touch panel 100.

Furthermore, a portion of the insulating photo-sensitive material layer 112 of the conductive photoresist film 120 in the peripheral area 100P of the touch panel 100 is removed, so that the insulating photo-sensitive material layer 112 has an opening formed in the peripheral area 100P of the touch panel 100. Additionally, the wires 108 and the conductive pad 108P located in the peripheral area 100P of the touch panel 100 are formed over the substrate 102 and in the opening of the insulating photo-sensitive material layer 112.

As shown in FIG. 4, in this embodiment, the insulating photo-sensitive material layer 112 in the active area 100A of the touch panel 100 is not patterned. Therefore, the difference in height of structure of the embodiment shown in FIG. 4, i.e. the depth labeled by d, is smaller than the difference in height of structure of embodiment shown in FIG. 2, i.e. the thickness of the conductive photoresist film 120. In some embodiments, the difference in height of the structure of the embodiment shown in FIG. 4 is between 0.4 um and 0.7 um. The difference in height of the structure of the embodiment shown in FIG. 2 is equivalent to the thickness of the conductive photoresist film 120 which is between 2.5 um and 5 um in some embodiment.

Due to the small difference in height of the structure of the embodiment shown in FIG. 4, the etching marks of the second electrodes 106 and the dummy second electrodes 106D of the touch panel 100 can be reduced. Additionally, the insulating photo-sensitive material layer 112 of the embodiment shown in FIG. 4 completely covers the first electrodes 104 in the active area 100A. Therefore, short-circuits between the second electrodes 106 and the first electrodes 104 can be prevented. In addition, as shown in FIG. 4, the thickness of the insulating photo-sensitive material layer 112 between two adjacent second electrodes 106 (or between two adjacent dummy second electrodes 106D) is smaller than a thickness of the insulating photo-sensitive material layer 112 that contacts with the second electrodes 106 in the active area (or contacts with the dummy second electrodes 106D).

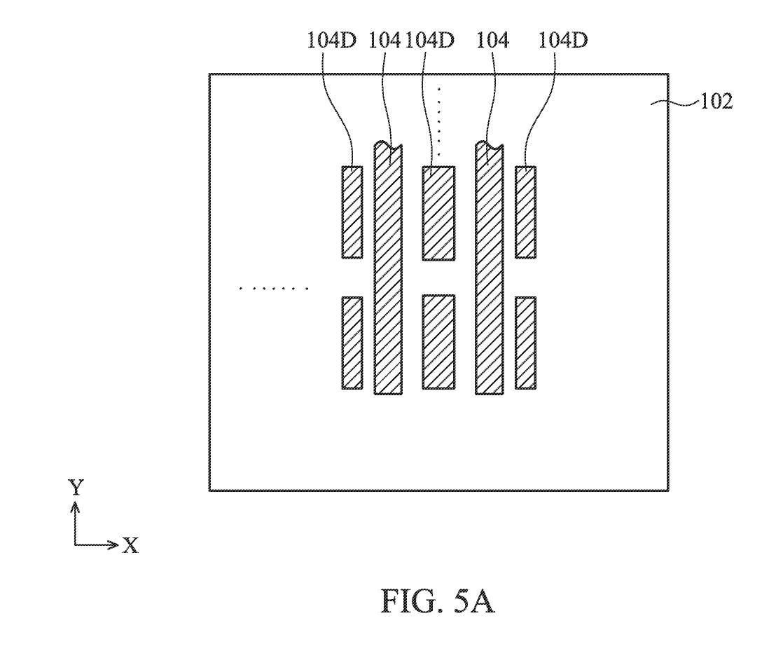

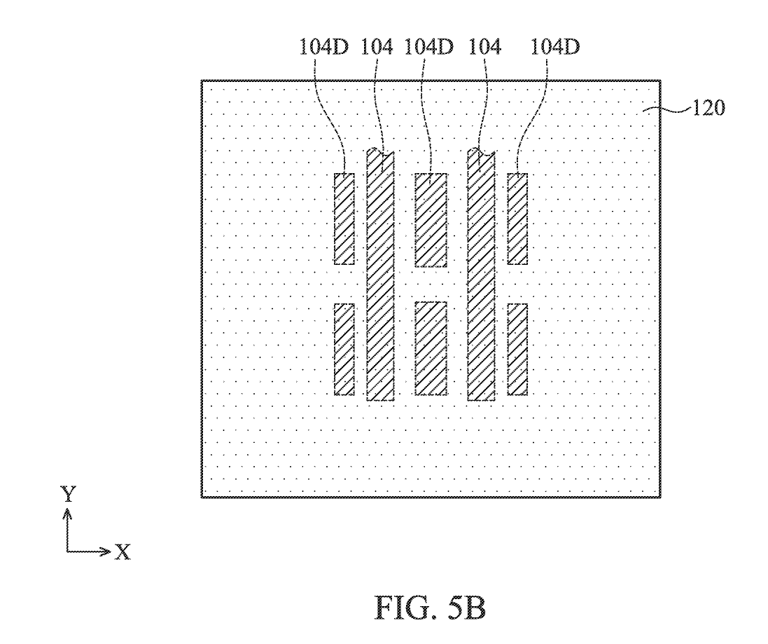

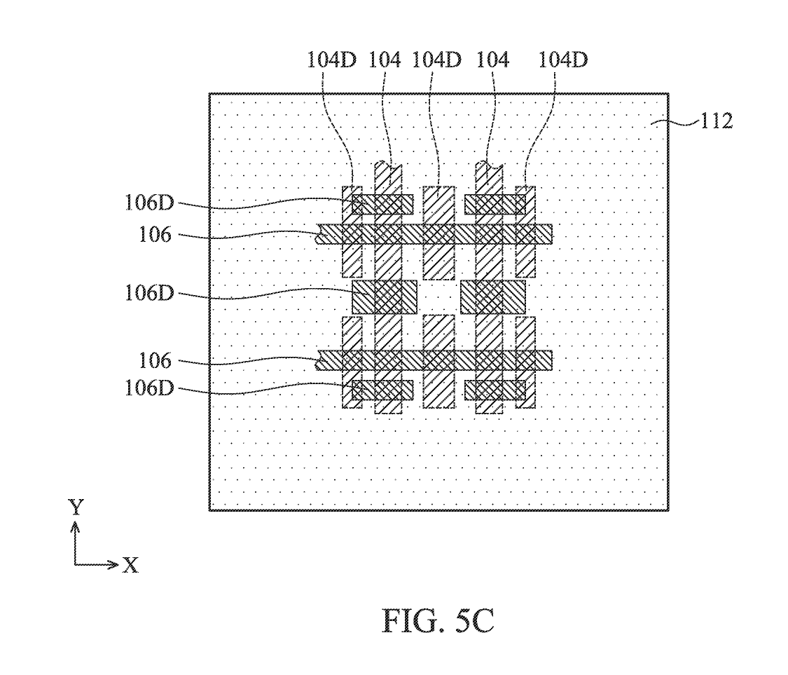

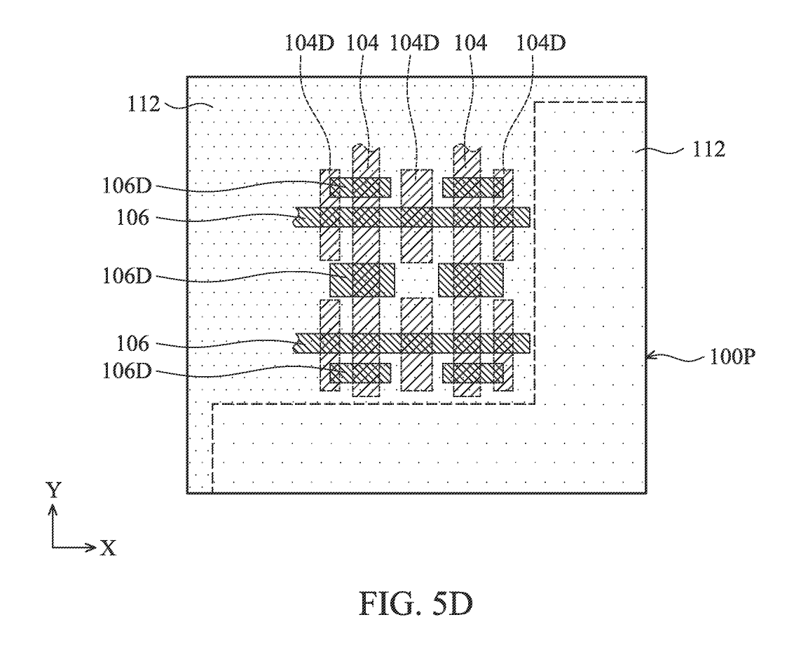

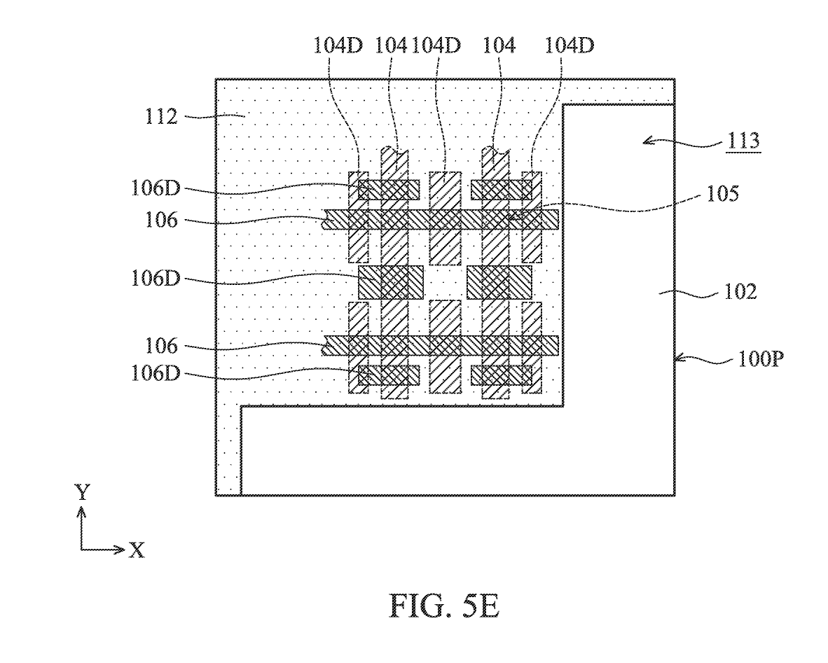

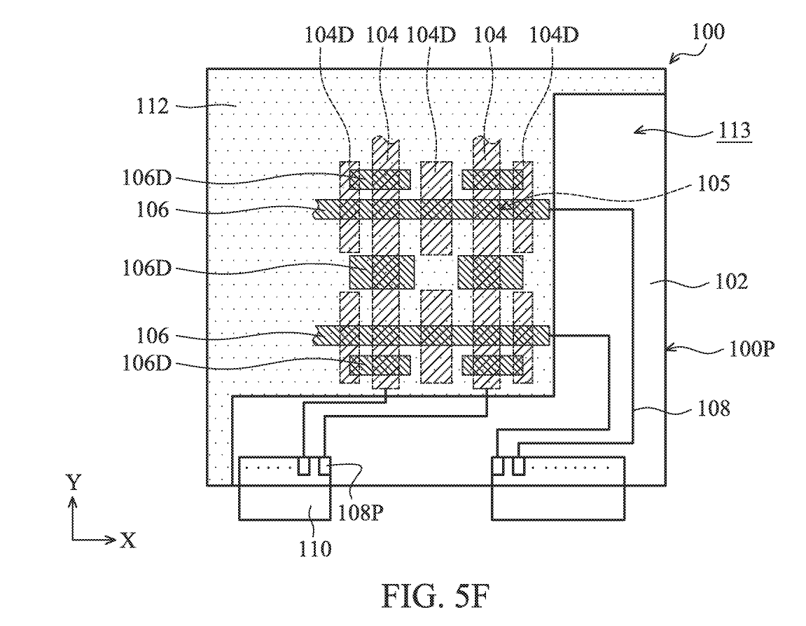

FIG. 5A-5F shows a plane view of the intermediate steps in the fabrication of a touch panel 100 with respect to FIG. 4 according to some embodiments of the disclosure. As shown in FIG. 5, the first electrodes 104 and the dummy first electrodes 104D are formed over the substrate 102. In some embodiments, an indium tin oxide (ITO) layer can be deposited over the substrate 102, and a photoresist layer can be formed over the indium tin oxide (ITO) layer. A photoresist pattern that matches the pattern of the first electrodes 104 and the dummy first electrodes 104D is formed by an exposure and development process. The photoresist pattern is used as a mask, and the first electrodes 104 and the dummy first electrodes 104D are formed by patterning the indium tin oxide (ITO) layer in an etching process.

Referring to FIG. 5B, the conductive photoresist film 120 is attached on the substrate 102 for covering the first electrodes 104 and the dummy first electrodes 104D. At this point, the conductive photoresist film 120 includes a non-patterned conductive layer and a non-patterned insulating photo-sensitive material layer underlying the conductive layer.

As shown in FIG. 5C, the exposure process is performed on the conductive photoresist film 120 by using the mask pattern that matches the pattern of the second electrodes 106 and the dummy second electrodes 106D. The conductive layer of the non-exposure area of the conductive photoresist film 120 is stripped for forming the second electrodes 106 and the dummy second electrodes 106D (as shown in FIG. 4 with respect to the conductive layer 111). The insulating photo-sensitive material layer 112 of the conductive photoresist film 120 still remains over the substrate 102. In the step of performing the stripping on the conductive layer of the conductive photoresist film 120, a portion of a surface of the insulating photo-sensitive material layer 112 underlying the stripped portion of the conductive layer is also stripped for forming the recess 112U which is a little lower than other surfaces of the insulating photo-sensitive material layer 112 (as shown in the FIG. 4).

Referring to FIG. 5D, a portion of the insulating photo-sensitive material layer 112 of the conductive photoresist film 120 is exposed for completely exposing the insulating photo-sensitive material layer 112 in the active area 100A of the touch panel 100, and the insulating photo-sensitive material layer 112 in the peripheral area 100P of the touch panel 100 is not exposed.

As shown in FIG. 5E, a development process is performed on the insulating photo-sensitive material layer 112 of the conductive photoresist film 120. After the development process, the non-exposure insulating photo-sensitive material layer 112 is removed for forming an opening 113 in the peripheral area 100P of the touch panel 100, and then the insulating photo-sensitive material layer 112 as shown in FIG. 4 is formed.

As shown in FIG. 5F, a plurality of wires 108 and conductive pads 108P on the end side of the wires 108 are formed over the substrate 102 in the peripheral area 100P of the touch panel 100. The wires 108 and the conductive pads 108P are located within the opening 113 of the insulating photo-sensitive material layer 112. In some embodiments, by using a screen print process, silver paste is used for printing the pattern of the wires 108 and the conductive pads 108D, and then the wires 108 and the conductive pads 108D are formed in a baking process. Additionally, a laser etching process can be performed for reducing the line width of the wires 108. When the insulating photo-sensitive material layer 112 is dry film photoresist, bubbles may be generated between the first electrodes 104 and the insulating photo-sensitive material layer 112 while the conductive photoresist film 120 doesn't attach on the first electrodes 104 and the dummy first electrodes 104D well. However, it hard to distinguish between the insulating photo-sensitive material layer made of dry film photoresist and the insulating photo-sensitive material layer formed by a coating process if no bubbles generate between the insulating photo-sensitive material layer 112 and the first electrodes 104.

In some embodiments, the substrate 102 of the touch panel 100 of the disclosure may be joined to a display panel by an adhesive layer for forming a touch display device. The display panel can be a liquid-crystal display (LCD) or an organic light-emitting diode (OLED) display panel.

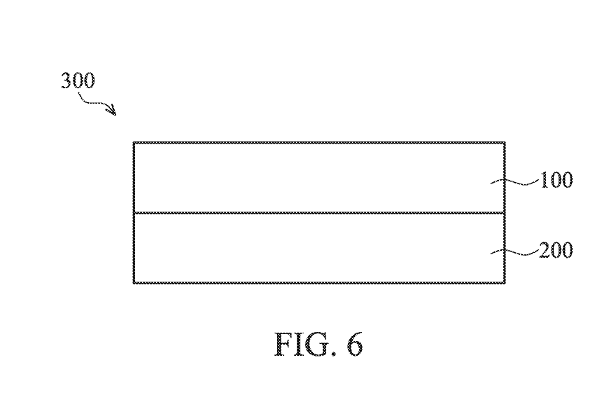

FIG. 6 shows a cross section of a display device according to some embodiments of the disclosure. In some embodiments, as shown in FIG. 6, a display device 300 includes a display panel 200 and the touch panel 100. The touch panel 100 is disposed on the display panel 200, wherein the substrate 102 of the touch panel 100 is disposed on the display panel (not shown). In this embodiments, the disposition of the dummy first electrodes 104D and the dummy second electrodes 106D improve the sensitivity of the touch sensor and reduces the visual problems caused by the visible shape of the first electrodes 104 and the second electrodes 106. Therefore, the display device 300 improves the visual problems by disposition of the touch panel 100.

According to the embodiments of the disclosure, the first and second electrodes of the touch panel use the bar-type electrode pattern design. When an alignment shift occurs between the first electrode and the second electrode, the overlapping area of the intersection of the first electrodes and the second electrodes does change. Therefore, even if an alignment shift occurs, the total capacitance of the touch sensor electrodes does not change greatly, so that the accuracy of the alignment between the first and second electrodes affects the touch sensor sensitivity only slightly, and the yield of manufacturing the touch panel is thereby improved.

Additionally, according to the embodiments of the disclosure, manufacturing the touch panel using the conductive photoresist film can integrate the process of forming a layer of the electrode pattern and the insulating layer of the touch panel. Therefore, the process of manufacturing touch panel is simplified.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch panel, comprising:
a substrate;
a plurality of first electrodes disposed over the substrate in an active area, wherein the first electrodes are parallel to each other and extend along a first direction; and
a conductive photoresist film disposed over the first electrodes, wherein the conductive photoresist film includes an insulating photo-sensitive material layer and a plurality of second electrodes, the second electrodes are parallel to each other and extend along a second direction, the second direction is perpendicular to the first direction, and the insulating photo-sensitive material layer is between the first electrodes and the second electrodes.

2. The touch panel of claim 1, wherein the insulating photo-sensitive material layer has a pattern that matches the pattern of the second electrode pattern.

3. The touch panel of claim 2, wherein the second electrodes and the insulating photo-sensitive material layer which is between the first electrodes and the second electrodes have a common tilt side, and the common tilt side has an angle between 30° and 85° with respect to the surface of the first electrodes.

4. The touch panel of claim 1, wherein the insulating photo-sensitive material layer in the active area of the touch panel completely covers the active area of the touch panel.

5. The touch panel of claim 4, wherein the insulating photo-sensitive material layer has an opening in a peripheral area of the touch panel.

6. The touch panel of claim 5, further comprising a plurality of wires electrically connected to the first electrodes and the second electrodes, wherein the wires are disposed over the substrate and in the opening of the insulating photo-sensitive material layer;

7. The touch panel of claim 1, wherein the material of the first electrodes is silver nanowires, carbon nanotube (CNT), indium tin oxide (ITO), indium zinc oxide (IZO), grapheme, conductive polymer, or metal.

8. The touch panel of claim 1, wherein the material of the second electrodes is silver nanowires, and a thickness of the conductive photoresist layer is between 1 um and 15 um.

9. The touch panel of claim 8, wherein an overlapping area of the first electrodes and the second electrodes is between 0.04 mm² and 1.08 mm².

10. The touch panel of claim 1, wherein a thickness of the insulating photo-sensitive material layer between two adjacent second electrodes is smaller than a thickness of the insulating photo-sensitive material layer that contacts with the second electrodes in the active area.

11. The touch panel of claim 6, wherein at least a part of the first electrodes extended to the opening of the insulating photo-sensitive material layer.

12. A method for forming a touch panel, comprising:
forming a plurality of first electrodes over a substrate, wherein the first electrodes are parallel to each other and extend along a first direction;
attaching a conductive photoresist film on the first electrodes, wherein the conductive photoresist film includes an insulating photo-sensitive material layer and a conductive layer; and
patterning the conductive layer for forming a plurality of second electrodes, wherein the second electrodes are parallel to each other and extend along a second direction, the second direction is perpendicular to the first direction, and the insulating photo-sensitive material layer is between the first electrodes and the second electrodes.

13. The method of claim 12, further comprising patterning the insulating photo-sensitive material layer, so that the insulating photo-sensitive material layer has a pattern that matches the pattern of the second electrode, wherein the step of patterning the conductive layer and the step of patterning the insulating photo-sensitive material layer are performed thorough the same exposure and development process.

14. A display device, comprising:
a display panel; and
a touch panel disposed on the display panel, wherein the touch panel comprising:
a substrate, wherein the substrate is disposed on the display panel;
a plurality of first electrodes disposed over the substrate in an active area, wherein the first electrodes are parallel to each other and extend along a first direction; and
a conductive photoresist film disposed over the first electrodes, wherein the conductive photoresist film includes an insulating photo-sensitive material layer and a plurality of second electrodes, the second electrodes are parallel to each other and extend along a second direction, the second direction is perpendicular to the first direction, and the insulating photo-sensitive material layer is between the first electrodes and the second electrodes.
